(19) United States
(12) Patent Application Publication
(10) Pub. No.: US 2022/0337979 A1
(43) Pub. Date: Oct. 20, 2022

(54) Wireless Sensor Bridge with Wireless Node and Wireless Hub

(71) Applicant: Maarten Van Laere, Heverlee (BE)

(72) Inventor: Maarten Van Laere, Heverlee (BE)

(21) Appl. No.: 17/714,878

(22) Filed: Apr. 6, 2022

Related U.S. Application Data
(60) Provisional application No. 63/171,519, filed on Apr. 6, 2021.

(51) Int. Cl. H04W 4/38; H04B 1/3827

(52) U.S. Cl. CPC H04W 4/38; H04B 1/3827; H04W 88/182

(57) ABSTRACT

The Wireless-Node-Hub invention is a dual device invention for enabling wired sensor platforms to become wireless without the need of changing the sensors or the base unit(s) to which they are connected; but rather rely on modules which plug into the sensors and base units which enable the normally wired communication to become now wireless.

### FEDERALLY SPONSORED RESEARCH

Not Applicable

### SEQUENCE LISTING OR PROGRAM

Not Applicable

### TECHNICAL FIELD OF THE PRESENT INVENTION

The present invention relates generally to sensor platforms. The present invention specifically relates to a new way to enable to offer a wireless sensor platform on top of an existing wired sensor platform without having to modify existing hardware.

### BACKGROUND OF THE PRESENT INVENTION

Sensor platforms have existed in wired and wireless forms whereby sensors send their data to a receiving unit either using a physical cable or using a wireless communication. Wired connections have the great benefit of being able to send data in real time where wireless sensors typically send periodically their data but can cover greater distances.

Some sensor manufacturers may offer only wired or wireless sensors. Others may offer a hybrid environment in which they support wired and wireless sensors on their platform.

When a sensor manufacturer wants to offer both wired and wireless sensors, then it typically has two options: either develop different versions of each sensor to support either wired or wireless connectivity; or current sensors that support both.

### SUMMARY OF THE INVENTION

With the present invention we create a new way to enable to offer a wireless sensor platform on top of an existing wired sensor platform without having to modify existing hardware. Instead with the present invention we enable to enable existing wired sensors to communicate wireless with the base units that they used to be connected to directly or indirectly with a cable.

The present invention relates to 2 devices or systems:

The first device is a hardware device that plugs into a sensor; a sensor that was designed for wired communications. The device can bridge the normally wired communication between the sensor and the base unit over a wireless communication. This first device is what we call the Wireless Node in the present invention.

The second device can be either an external hardware device connected to the base unit or it can be embedded into the base unit. This second device is what we call the Wireless Hub in the present invention. The Wireless Hub communicates with the Wireless Node to send and/or receive information from the Wireless Node and transmit it to the base unit.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a device enabling sensors, that are normally connected via a wired connection, into wireless sensors using an adapter. While such adapters may exist they are designed to integrate wired sensors with other receiving units than the original ones the sensors were connected to.

Another object of this invention is that the sensors with the invented device connect over a wireless communication protocol directly or indirectly to the same base unit to which the sensor was originally connected to using a wired connection.

Another object is that to enable such wireless upgrade functionality, the base unit can be extended with a wireless communication system that is either embedded into the base unit or externally connected to the base unit.

Another object is to provide backwards compatibility. This means to be able to implement the wireless communication into existing sensor platforms that normally only support direct or indirect wired communications between sensors and their base units. The wireless communication system embedded or externally connected to the base unit and/or the wireless node module will emulate wired connections so that the method of connectivity between base unit and sensor is transparent for either.

Another object is to provide a device that is designed in such a way that wireless communications are physically isolated and shielded from internal networks to which a base unit is connected to. This provides increased security as possible attacks originating from the wireless networks are limited to the invention's Wireless hub and do not expose internal networks to the outside world.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

The accompanying drawings, which are incorporated herein and form a part of the specification, illustrate the present invention and, together with the description, further serve to explain the principles of the present invention and to enable a person skilled in the pertinent art to make and use the present invention.

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1: Drawing of a possible implementation of the invention: a Wireless Hub connected to the base unit and a Wireless Node that connects using a cable to the sensor.

### INDEX OF ELEMENTS

10: Wireless Hub
20: Base unit for sensor(s)
30: Sensor port(s)
40: RJ45 cables used to connect sensor(s) to the base unit
50: Sensor
60: Wireless Node
70: Wireless Communication

### DETAILED DESCRIPTION OF THE PRESENT INVENTION

In the following detailed description of the present invention of exemplary embodiments of the present invention, reference is made to the accompanying drawings (where like numbers represent like elements), which form a part hereof, and in which is shown by way of illustration specific exemplary embodiments in which the present invention may be practiced. These embodiments are described in sufficient detail to enable those skilled in the art to practice the present invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the present invention. However, it is understood that the present invention may be practiced without these specific details. In other instances, well-known structures and techniques known to one of ordinary skill in the art have not been shown in detail in order not to obscure the present invention. Referring to the figures, it is possible to see the various major elements constituting the apparatus of the present invention.

A. Overview

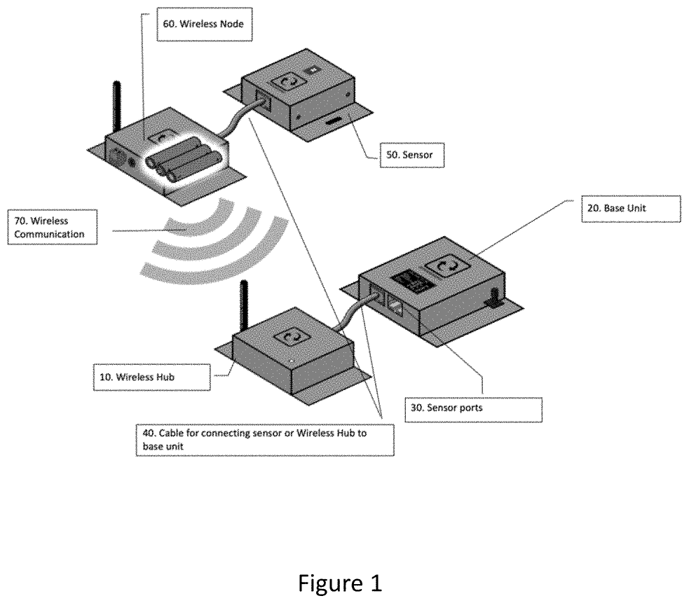

Turning now descriptively to the drawings, in which similar reference characters denote similar elements throughout the several views, FIG. 1 illustrates the Wireless Hub (10) being connected using a wired connection (40) to a sensor port (30) of the base unit (20); then a Wireless Node (60) which is connected using a wired connection to a sensor (50). The Wireless Hub (10) now communicates over wireless protocol(s) (70) with the Wireless Node (60).

B. Wireless Node

Without the Wireless Node, sensors (50) connect using a wired connection directly or indirectly to one or more base units (20).

With the invented Wireless Node, sensors (50) designed for a wired connection can transmit their data over wireless communication protocols to one or more base units (20).

Next to bridging the wired communication into a wireless communication, the Wireless Node (60) can also cater for the power required by the sensor to operate. Typically it is the base unit that provides power to the sensor when both are connected via a wired connection.

Another possible feature of the Wireless Node is its ability to emulate a wired connection for the sensor making the sensor believe that it is connected a base unit.

C. Wireless Hub

The Wireless Hub (10) is connected to or embedded in the base unit (20). It receives or transmits data from the base unit to the sensor through the Wireless Node (60).

Another possible feature of the Wireless Hub is its ability to emulate a wired connection from the sensor (50) for the base unit (20). In such an embodiment the base unit believes that it has a sensor (50) connected to it using a wired connection (40). The Wireless Hub (10) buffers the communication between itself and the Wireless Node (60) so that there is no delay for the base unit (20) in receiving data that could be periodic from the Wireless Node (60), especially when the Wireless Node (60) is battery operated.

D. Base Unit

Typically the base unit (20) in a sensor platform is a logical device to which one or more sensors can be connected to. The base unit can either work stand-alone or be connected in its turn to other applications, servers, systems or any other type of device.

E. Sensor Ports & Communication

In a wired sensor platform, sensors connect to the base unit using a cable that is plugged into ports for sensors on the base units. Some base units have the option to expand the number of ports by using an expansion unit; this increases the number of ports that sensors can connect to.

The communication protocol between a wired sensor and base unit is typically not a data network based protocol such as TCP/IP but more often an industrial open or proprietary communication protocols and methods such as, but not limited to, RS232 or RS485. The cable (40) used between sensor (50) and base unit (20) transmits the data between sensor and the base unit and it can also transmit power either way. A non-limitative example of common cables for this purpose are RJ45 and RJ11 data cables. In (40) we've used a RJ45 network cable as illustration.

F. Wireless Communication Protocols

The invention transmits data over wireless communication protocols such as, but not limited to, Zigbee, Bluetooth or LoRa. The invention could support one or multiple wireless communication protocols at the same time.

The wireless communication between the Wireless Node (60) and the Wireless Hub (10) can either be a point to point direct communication or a meshed communication.

G. Connections of Main Elements and Sub-Elements of Invention

A typical implementation of this invention would be a device that includes the features as described above. This first device, the Wireless Hub (10), would then connect, directly or indirectly, using a wired connection (40) into a port (30) on the base unit (20) that is provisioned to support sensors. The sensors (50) would in turn connect to the second device, the Wireless Node (60), using a cable (40).

H. Alternative Embodiments of Invention

A first possible and non-exhaustive alternative embodiment of the first device, the Wireless Hub (10), would be embedded into the base unit (20) rather than being externally connected like in FIG. 1. Another one is whereby the Wireless Hub (10) connects to the base unit without requiring the cable (40). Another possible one is that the Wireless Hub (10) would connect to the base unit (20) using a different mechanism than by using the sensor port (30).

A possible and non-exhaustive alternative embodiment of the second device, the Wireless Node (60), is that the device connects to the sensor without requiring the cable (40).

I. Operation of Preferred Embodiment

FIG. 1 outlines the preferred embodiment of the present invention.

Without the present invention, the sensor (50) would connect with a cable (40) to the base unit (20) by plugging it into a sensor port (30).

With the invention, the communication between sensor (50) and base unit (20) is no longer wired but becomes wireless using wireless communication protocols (70).

To make this possible, the sensor (50) now plugs into the Wireless Node (60). The Wireless Hub (10) connects to the base unit (20). The communication between Wireless Node (60) and Wireless Hub (10) is now wireless; making the communication between sensor (50) and base unit (60) wireless.

What has been described and illustrated herein is a preferred embodiment of the invention along with some of its variations. The terms, descriptions and FIGURES used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect. What has been described and illustrated herein is a preferred embodiment of the invention along with some of its variations. The terms, descriptions and FIGURES used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What has been described and illustrated herein is a preferred embodiment of the present invention along with some of its variations. The terms, descriptions and FIGURES used herein are set forth by way of illustration only and are not meant as limitations. Those skilled in the art will recognize that many variations are possible within the spirit and scope of the present invention in which all terms are meant in their broadest, reasonable sense unless otherwise indicated. Any headings utilized within the description are for convenience only and have no legal or limiting effect.

Thus, it is appreciated that the optimum dimensional relationships for the parts of the present invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the present invention should be determined by the appended claims and their legal equivalents, rather than by the examples given.

The embodiments of the present invention in which an exclusive property or privilege is claimed are defined as follows:

1. A wireless sensor bridge with wireless node and wireless nub, the device comprising:
a wireless hub;
one or more base units;
a sensor port located on the base unit;
one or more sensors;
the wireless hub being connected using a wired connection to the sensor port of the base unit;
a wireless node connected using a wired connection to the sensor;
the wireless hub communicates over wireless protocol(s) with the wireless node.

2. The device of claim 1, wherein
without the wireless node, sensors connect using a wired connection directly or indirectly to one or more base units.

3. The device of claim 1, wherein
sensors designed for a wired connection transmit their data over wireless communication protocols to one or more base units.

4. The device of claim 1, wherein
the wireless node caters for the power required by the sensor to operate.

5. The device of claim 1, wherein
the base unit that provides power to the sensor when both are connected via a wired connection.

6. The device of claim 1, wherein
the wireless node has the ability to emulate a wired connection for the sensor, making the sensor believe that it is connected a base unit.

7. The device of claim 1, wherein
the wireless hub is connected to or embedded in the base unit;
and the wireless hub receives or transmits data from the base unit to the sensor through the wireless node.

8. The device of claim 1, wherein
the wireless hub has the ability to emulate a wired connection from the sensor for the base unit; and
the base unit believes that it has a sensor connected to it using a wired connection.

9. The device of claim 8, wherein
the wireless hub buffers the communication between itself and the wireless node so that there is no delay for the base unit in receiving data from the wireless node.

10. The device of claim 9, wherein
the wireless node is battery operated.

11. The device of claim 1, wherein
the base unit in a sensor platform is a logical device to which one or more sensors can be connected to; and
the base unit either works stand-alone or is connected in its turn to other applications, servers, or systems.

12. The device of claim 1, wherein
in a wired sensor platform, sensors connect to the base unit using a cable that is plugged into ports for sensors on the base units; and
some base units have the option to expand the number of ports by using an expansion unit; this increases the number of ports that sensors can connect to;
the communication protocol between a wired sensor and base unit is typically not a data network based protocol such as TCP/IP but more often an industrial open or proprietary communication protocols and methods such as, but not limited to, RS232 or RS485;
the cable used between sensor and base unit transmits the data between sensor and the base unit and it can also transmit power either way.

13. The device of claim 1, wherein
the wireless communication between the wireless node and the wireless hub are either a point to point direct communication or a meshed communication.

14. A wireless sensor bridge with wireless node and wireless nub, the device comprising:
a wireless hub connected, directly or indirectly, using a wired connection into a port on a base unit that is provisioned to support sensors;
the sensors in turn connect to a wireless node using a cable.

15. The device of claim 14, wherein
the wireless hub is embedded into a base unit.

16. The device of claim 14, wherein
the wireless hub connects to the base unit without requiring the cable.

17. The device of claim 14, wherein
the wireless hub connects to the base unit using a different mechanism than by using the sensor port.

18. The device of claim 14, wherein
the wireless node connects to the sensor without requiring the cable.

19. The device of claim 14, wherein
the sensor connects with a cable to the base unit by plugging the sensor into a sensor port;
the communication between sensor and base unit is no longer wired but becomes wireless using wireless communication protocols; and
the sensor plugs into the wireless node;
the wireless hub connects to the base unit; and
the communication between the wireless node and wireless hub is now wireless; making the communication between sensor and base unit wireless.
